(19) United States
(12) Patent Application Publication
(10) Pub. No.: US 2015/0245739 A1
(43) Pub. Date: Sep. 3, 2015

(54) TRIVET

(71) Applicant: Robinson Home Products Inc., Williamsville, NY (US)

(72) Inventors: Lou Henry, Scarsdale, NY (US); John Healy, Brooklyn, NY (US)

(73) Assignee: Robinson Home Products Inc., Williamsville, NY (US)

(21) Appl. No.: 14/194,112

(22) Filed: Feb. 28, 2014

(51) Int. Cl. A47J 36/34

(52) U.S. Cl. CPC A47J 36/34

(57) ABSTRACT

A trivet comprising a body with a perimeter having a notch, the notch having a leading wall which is at an angle less than 90° from an adjacent leading perimeter. The notch may also have a trailing wall which is at an angel of greater than 90° from an adjacent trailing perimeter.

### FIELD OF THE INVENTION

The present invention relates to a trivet that can also be used as a potholder, and more specifically to a potholder or trivet that is used for handling hot items in the kitchen.

### BACKGROUND OF THE INVENTION

Potholders are important kitchen tools, used in the kitchen to prevent burns when holding or manipulating hot pots, pans, utensils and equipment or when placing a hot item on a countertop, etc. In this regard, common potholders are often flat and can be used as trivets if flexible enough to be formed around pot handles and the like. These items are often used in a kitchen to prevent burns to skin, a countertop or the like caused by hot plates, pots, pans, trays, utensils, kitchen equipment and the like. For the purposes of this application the term trivet will be used to describe the device of the present invention whether used as a potholder or trivet.

It is also known that the amount of control which can be exerted over the hot item being handled is often limited when using potholders and trivets. More particularly, trivets are often thick to insulate the heat from the hot item being handled. The thickness, however, causes reduced feel over the item being handled. Although this is not a great concern when using the trivet to handle larger items, such as pots and pot handles, it becomes more of a concern when the user needs to handle smaller hot items.

Additionally, it is generally less preferred to have a variety of kitchen items to handle related tasks in a kitchen, since the use of multiple kitchen tools or gadgets takes up valuable space. Therefore, it is preferred to have a device that can function to perform multiple related tasks without the need for multiple devices.

In keeping, a trivet that is high temperature resistant to handle oven temperatures and stovetop pots, as well as being able to engage smaller items that are more difficult to grasp with a traditional trivet would advance the art.

### SUMMARY OF THE INVENTION

These and other deficiencies of the prior art are addressed by the device of the present invention, which is directed to a trivet comprising a body with a perimeter, said perimeter comprising a notch having a leading wall, wherein the angle formed between the leading wall and the adjacent leading perimeter of the body is less than 90°. The leading edge of the notch is therefore formed as a hook that is capable of engaging a bar of an oven rack and pulling the oven rack out of an oven.

In the preferred embodiment, the notch further comprises a trailing wall, where the angle between the trailing wall and the adjacent trailing perimeter of the body is greater than 90°, to aid in directing the bar of the oven rack into the notch. It is also preferred that the notch have an interior wall between the leading wall and trailing wall which is substantially parallel to the line of the perimeter of the body, with a radius connecting the leading wall and the interior wall.

In the preferred embodiment, the perimeter includes a substantially flat side having an end point where the perimeter changes direction from the flat side to an adjacent side. For example, the perimeter is preferably in the shape of a square, a rectangle, a triangle, a truncated circle, etc., where the flat side terminates at an adjacent side. In such an embodiment it is preferred that the leading edge of the notch is proximate the end point of the flat side where the notch is placed.

In a most preferred embodiment the leading wall of the notch, and preferably both the leading wall and interior wall of the notch, comprises a reinforcing member. Such a reinforcing member may the a thickened perimeter in at least in the area of the notch, however, a reinforcing member in the form of a material with increased structural integrity formed within the perimeter in the area of the notch is most preferred. Such a structure may be manufactured by placing a nylon element in a mold which is then filled with the silicone elastomeric material of the body to cover the nylon element.

It is preferred that the body of the trivet is flexible or malleable, so that the trivet may be used as a potholder. Due to the need for high temperature resistance, the trivet is preferably formed of a high temperature resistant thermoplastic elastomeric material and most preferably of a flexible silicone based thermoplastic elastomeric material.

The reinforcing member is preferably also formed of a high temperature resistant material, and may also be covered by the silicone based thermoplastic elastomeric material to provide high temperature resistance. Holes, depressions or other surface features may be incorporated into the body to help disburse heat and/or for aesthetic purposes.

### BRIEF DESCRIPTION OF THE DRAWINGS

The present invention will be better understood when considered in view of the attached drawings, in which like reference characters indicate like parts. The drawings, however, are presented merely to illustrate the preferred embodiment of the invention without limiting the invention in any manner whatsoever.

FIG. 1 is a perspective view of the preferred trivet of the present invention.

FIG. 2 is a side elevation of the trivet of FIG. 1.

FIG. 3 is a partial side elevation of the trivet, illustrating the preferred notch.

### DETAILED DESCRIPTION OF THE PREFERRED EMBODIMENT

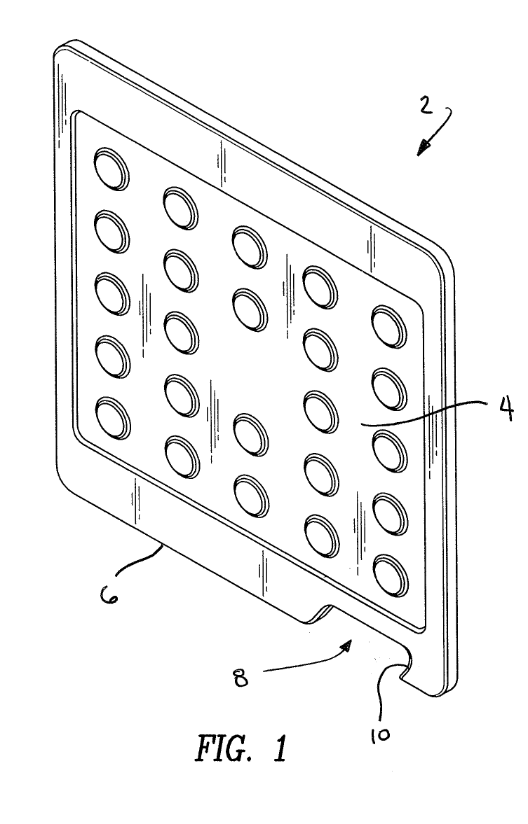

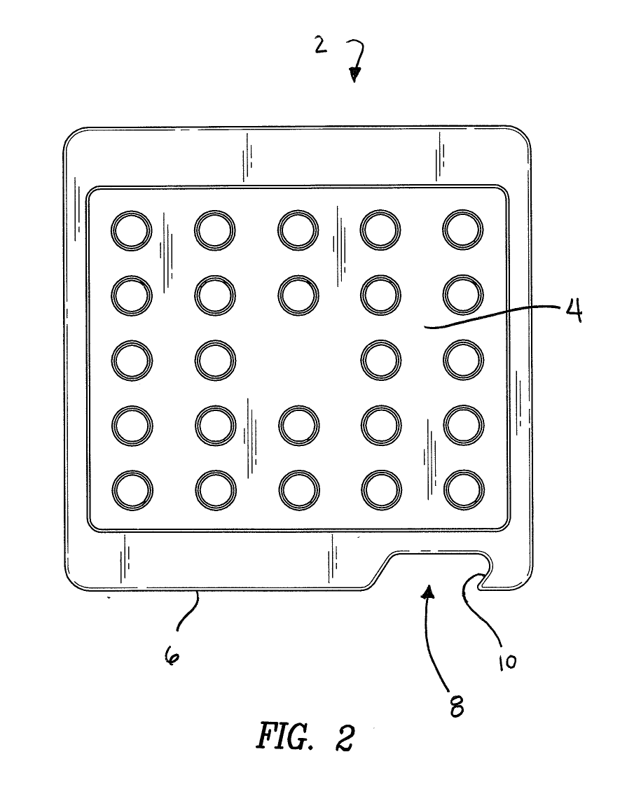

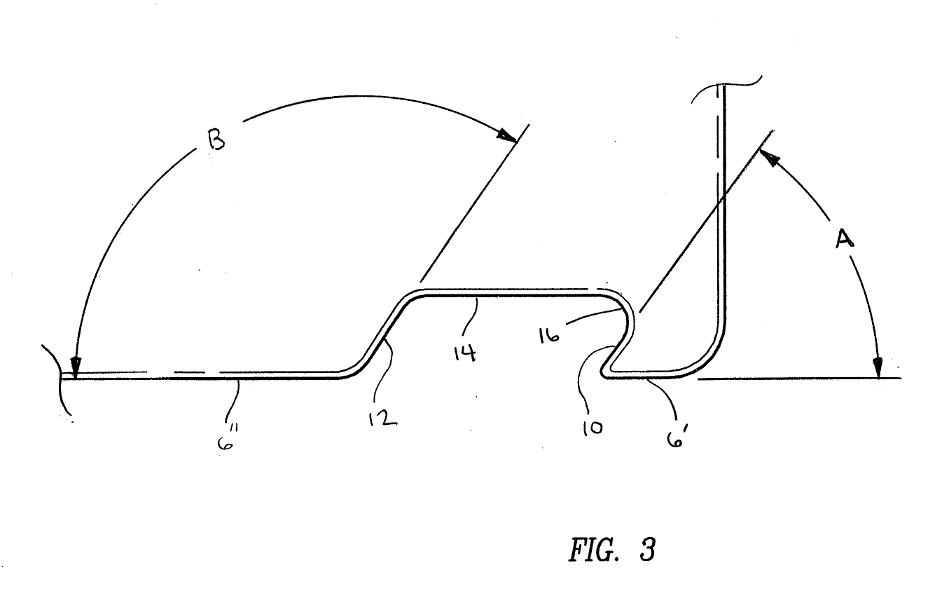

In a preferred embodiment, shown in accompanying FIGS. 1-3, the trivet 2 comprises a malleable body 4 with a perimeter 6, said perimeter 6 comprising a notch 8 having a leading wall 10, wherein the angle A formed between the leading wall 10 and the adjacent leading perimeter 6′ is less than 90° to form a hook.

The preferred notch 8 further comprises a trailing wall 12, where the angle B between the trailing wall 12 and the adjacent trailing perimeter 6″ is greater than 90°. This angle B opens the trailing edge of the notch 8 to aid in directing the bar of the oven rack into the notch 8. It is also preferred that the notch 8 have an interior wall 14 between the leading wall 10 and trailing wall 12 which is substantially parallel to the line of the perimeter of the body 6, with a radius 16 connecting the leading wall and the interior wall.

As shown in the accompanying drawings, the perimeter 6 of the body 4 in the area of the notch 8 is preferably flat and the notch 8 is positioned on the flat perimeter 6 with the leading wall 10 proximate the point where the flat side of the perimeter 6 meets an adjacent side. This positioning permits the user to grasp the trivet 2 farther from the notch 8 when attached to a bar of an oven rack, to limit the accidental contact between skin and a hot oven rack.

Additionally, the leading wall 10 and interior wall 14 of the notch 8, if not the entire notch 8, comprises a reinforcing member. Although the reinforcing member is shown in FIG. 1 as a thickened perimeter 6 about the body 4, but particularly in the area of the notch 8, the reinforcing member may be an insert formed of a material of increased structural integrity and high heat resistance that takes the general shape of the notch 8 and is set into the perimeter 6 of the body 4.

Due to the need for high temperature resistance, the body 4 of the trivet 2 is preferably formed of a high temperature resistant thermoplastic elastomeric material and most preferably of a silicone based thermoplastic elastomeric material. Holes, depressions or other surface features may be incorporated into the body 4 to help disburse heat and/or for aesthetic purposes, including a hang hole which can be used to hang the trivet 2 from a hook.

When an insert serves as the reinforcing member associated with the notch 8, whether forming the entire notch 8 and an adjacent portion of the perimeter 6 or an internal insert covered by the flexible silicone based thermoplastic elastomeric material of the body 4, the insert would preferably be formed of a high temperature resistant material. Of course, high temperature resistance may be somewhat limited when the reinforcing member is covered by the high temperature thermoplastic elastomeric material of the body 4, since the material of the body 6 would provide a level of high heat resistance.

Notwithstanding, it is believed that an insert formed of a plastic material, such as a nylon or other structural material may be incorporated into the mold for the trivet 2, which is then filled with the elastomeric material of the body to capture and/or cover the reinforcing member.

Variations, modifications and alterations to the above detailed description will be apparent to those skilled in the art. All such variations, modifications and/or alternatives are intended to fall within the scope of the present invention, limited only by any allowed claims. All cited patents and publications are hereby incorporated by reference.

We claim:

1. A trivet comprising a body with a perimeter, said perimeter comprising a notch having a leading wall which is at a first angle from an adjacent leading perimeter, wherein the first angle is less than 90°.

2. The trivet of claim 1 wherein the body is formed of a flexible high temperature resistant thermoplastic material.

3. The trivet of claim 1 wherein the trivet is formed of a flexible silicone based high temperature resistant thermoplastic material.

4. The trivet of claim 1 wherein the notch further comprises a trailing wall which is at a second angle from an adjacent trailing perimeter, wherein the second angle is greater than 90°.

5. The trivet of claim 1 wherein the perimeter of the body in the area of the notch is substantially flat.

6. The trivet of claim 5 wherein the notch is positioned on the substantially flat perimeter proximate a point where the flat side of the perimeter meets an adjacent side.

7. The trivet of claim 1 wherein the notch further comprises an interior wall between the leading wall and trailing wall.

8. The trivet of claim 7 wherein the interior wall is substantially parallel to the perimeter of the body in the area of the notch.

9. The trivet of claim 7 wherein the leading wall is connected to the interior wall by a radius.

10. The trivet of claim 1 further comprising a reinforcing member associated with at least the leading wall of the notch.

11. The trivet of claim 10 wherein the reinforcing member is taken from the group consisting of a thickened perimeter, an insert forming the notch and at least a portion of the perimeter in the area of the notch and an internal insert associated with at least the leading wall of the notch.

12. The trivet of claim 10 wherein the reinforcing member is an internal insert covered by a high temperature resistant thermoplastic material which forms the body of the trivet.

13. The trivet of claim 10 wherein the reinforcing member is formed of a plastic.

14. The trivet of claim 13 wherein the plastic is a high temperature resistant nylon.

15. The trivet of claim 1 wherein the body comprises holes, depressions or other surface features on at least one side.

16. The trivet of claim 15 wherein the holes, depressions or other surface features are on only one side.
